(19) United States
(12) Patent Application Publication
(10) Pub. No.: US 2002/0186525 A1
(43) Pub. Date: Dec. 12, 2002

(54) Attachment for handheld digital devices

(76) Inventor: Manmohan L. Singh, Phoenix, AZ (US)

Correspondence Address: The Halvorson Law Firm, Suite 1, 405 W. Southern Ave., Tempe, AZ, 85282, US

(21) Appl. No.: 09/789,045

(22) Filed: Jun. 11, 2001

(51) Int. Cl. G06F 1/16

(52) U.S. Cl. 361/680

(57) ABSTRACT

Presented is an attachment having a keyboard that is useful for expanding the data entry capability of pen-based computer devices or PDA's. The attachment comprises two basic sections, a keyboard section and an attachment section. The attachment section comprises an attachment enclosure having an I/O connector located within the attachment enclosure. The attachment enclosure is generally in the shape of an open-ended box or rectangular prism. In a preferred embodiment the attachment enclosure closely matches the size of the PDA such that the PDA is securely, but removable, contained by the attachment enclosure. Since there are a variety of differently shaped PDA's on the market, there may be a variety of differently sized attachment enclosures, each of which will have at least one open end and the I/O connector located within.

### BACKGROUND OF THE INVENTION

1. The Field of the Invention

The present invention relates to small portable keyboards that are attachable to handheld electronic devices and, more specifically, to a keyboard accessory for handheld electronic devices such as personal digital assistants (PDAs).

2. The Relevant Art

Small personal organizers, palm-size computers, combination phone/computers and other devices commonly known as personal digital assistants (PDAs) are in common use by the public. These devices are also known by many as “pen-based computers” because a user must use a stylus in order to enter data. Pen-based computers have grown in popularity for several reasons, chief amongst them being their small size and easy portability. Miniaturization of electronic components has made these devices increasingly powerful, versatile, and affordable.

There are two common methods for data entry utilizing the stylus: 1) tapping on an “onscreen software keyboard” with the stylus; and 2) using the stylus as a writing instrument by writing directly upon a pressure-sensitive layer. When tapping on the “on-screen keyboard”, the user selects the desired key or option by tapping an appropriate location with the stylus. When writing upon the pressure sensitive layer, the user moves the stylus to form characters that must be “recognized” as the characters formed by the user on the pressure-sensitive surface, this is known as “handwriting recognition.”

Many users, however, find the two available stylus data-entry methods cumbersome and prone to errors. The tapping method is typically slow, and the small screen area of PDAs increases the likelihood that a user will inadvertently make unintended selections. The handwriting recognition method affords the user greater flexibility and speed in making notations and composing messages, but it is prone to errors in recognition.

Most users of pen-based computers are already familiar with common keyboard designs since they are used on typewriters, standard computers, 10-key data entry devices, telephone keypads, and the like. Because of this previous familiarity, users are comfortable using keyboards for composing text and entering data into electronic devices. Therefore, there is a need to attach a keyboard to PDAs and other pen-based computers in order to facilitate text and data entry.

The prior art reveals that keyboards have been designed to be attached to the pen-based computers. See U.S. Pat. Nos. 5,638,257, 6,108,200, and 6,168,331 for example. These devices all attach full sized keyboards to the pen-based computers thereby allowing the user to type normally as with a typewriter or full-sized computer. However, in order to use these devices the keyboards must be placed upon a flat stable surface—one capable of supporting a full-sized computer or notebook computer. This negates the portable aspect that makes the pen-based computers so popular. Therefore, there is a need for a keyboard that is attachable to pen-based computer, yet is small enough to be hand-held when in use.

### SUMMARY OF THE INVENTION

It is an object of the present invention to provide a handheld computer keyboard attachment that is removably attachable to small computerized devices having no permanently attached keyboards.

It is another object of the present invention to provide a keyboard attachment that is comprised of a keyboard and an interface assembly including an I/O connector configured to engage an I/O port of a computerized apparatus.

The keyboard is preferably arranged in the common QWERTY layout and a plurality of additional buttons are arranged above the numeral keys, although other keypad and keyboard layouts are also used. These additional buttons are designed to have programmable functionality such that the user may associate with each button one or more computer commands that will be executed when the button is depressed. While these embodiments are aimed at providing a convenient portable keyboard for use with PDAs, other embodiments are envisioned that utilize less common keyboard designs, that are specific to other types of computerized apparatus of a similar form-factor, and that incorporate additional features such as additional I/O connectors, wireless modems, Global Positioning Satellite (GPS) receivers, and the like.

The present invention is advantageous to users of PDAs in that it provides them a better option for interacting with their PDAs. The use of a keyboard is more effective for most people than pen-based systems. The use of a keyboard instead of a stylus allows users to enter text and data more quickly and with a lower error rate. These advantages become more important when a PDA is used in a moving vehicle or by individuals with less steady hands, or by users who have not conditioned the PDA to recognize their own handwriting. The availability of buttons with programmable functionality allows users to customize their keyboard system to streamline repetitive tasks.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

The present invention will be readily understood by the following detailed description in conjunction with the accompanying drawings, with like reference numerals designating like elements.

FIG. 1. is a front view of a typical personal digital assistant.

FIG. 2. is a bottom view of a typical personal digital assistant.

FIG. 3. is a side view of a typical personal digital assistant.

FIG. 4. is a perspective view of a first embodiment of the attachment according to the present invention.

FIG. 5. is a front view of the first embodiment of the attachment according to the present invention.

FIG. 6. is a top view of the first embodiment of the attachment according to the present invention.

FIG. 7. is a bottom view of the first embodiment of the attachment according to the present invention.

FIG. 8. is a side view of the first embodiment of the attachment according to the present invention.

FIG. 9. is a front view showing the first embodiment of the attachment according to the present invention containing a personal digital assistant.

FIG. 10. is a side view showing the first embodiment of the attachment according to the present invention containing a personal digital assistant.

FIG. 11. is an exploded view showing the first embodiment of the attachment according to the present invention apart from a personal digital assistant.

FIG. 12. is a perspective view showing the first embodiment of the attachment according to the present invention containing a personal digital assistant.

FIG. 13. is a perspective view of a second embodiment of the attachment according to the present invention.

FIG. 14. is a front view of the second embodiment of the attachment according to the present invention.

FIG. 15. is a bottom view of the second embodiment of the attachment according to the present invention.

FIG. 16. is a side view of the second embodiment of the attachment according to the present invention.

FIG. 17. is a front view showing the second embodiment of the attachment according to the present invention containing a personal digital assistant.

FIG. 18. is a side view showing the second embodiment of the attachment according to the present invention containing a personal digital assistant.

FIG. 19. is an exploded view showing the second embodiment of the attachment according to the present invention apart from a personal digital assistant.

FIG. 20. is a perspective view showing the second embodiment of the attachment according to the present invention containing a personal digital assistant.

FIG. 21. is a perspective view of a third embodiment of the attachment according to the present invention.

FIG. 22. is a front view of the third embodiment of the attachment according to the present invention.

FIG. 23. is a bottom view of the third embodiment of the attachment according to the present invention.

FIG. 24. is a side view of the third embodiment of the attachment according to the present invention.

FIG. 25. is an exploded view showing the third embodiment of the attachment according to the present invention apart from a personal digital assistant.

FIG. 26. is a perspective view showing the third embodiment of the attachment according to the present invention containing a personal digital assistant.

FIG. 27. is a perspective view of a fourth embodiment of the attachment according to the present invention.

FIG. 28. is a front view of the fourth embodiment of the attachment according to the present invention.

FIG. 29. is a top view of the fourth embodiment of the attachment according to the present invention.

FIG. 30. is a bottom view of the fourth embodiment of the attachment according to the present invention.

FIG. 31. is a side view of the fourth embodiment of the attachment according to the present invention.

FIG. 32. is a front view showing the fourth embodiment of the attachment according to the present invention containing a personal digital assistant.

FIG. 33. is a side view showing the fourth embodiment of the attachment according to the present invention containing a personal digital assistant.

FIG. 34. is an exploded view showing the fourth embodiment of the attachment according to the present invention apart from a personal digital assistant.

FIG. 35. is a perspective view showing the fourth embodiment of the attachment according to the present invention containing a personal digital assistant, the dashed outline illustrates a not-in-use position of the keyboard section.

FIG. 36. is a partial side view of the fourth embodiment of the attachment according to the present invention.

FIG. 37. is a detailed view of the hinge mechanism of the forth embodiment illustrating movement of the keyboard section from a use position to a not-in-use position.

### DETAILED DESCRIPTION OF THE PREFERRED EMBODIMENTS

The present invention is an attachment 10 having a keyboard that is useful for expanding the data entry capability of pen-based computer devices or PDA's.

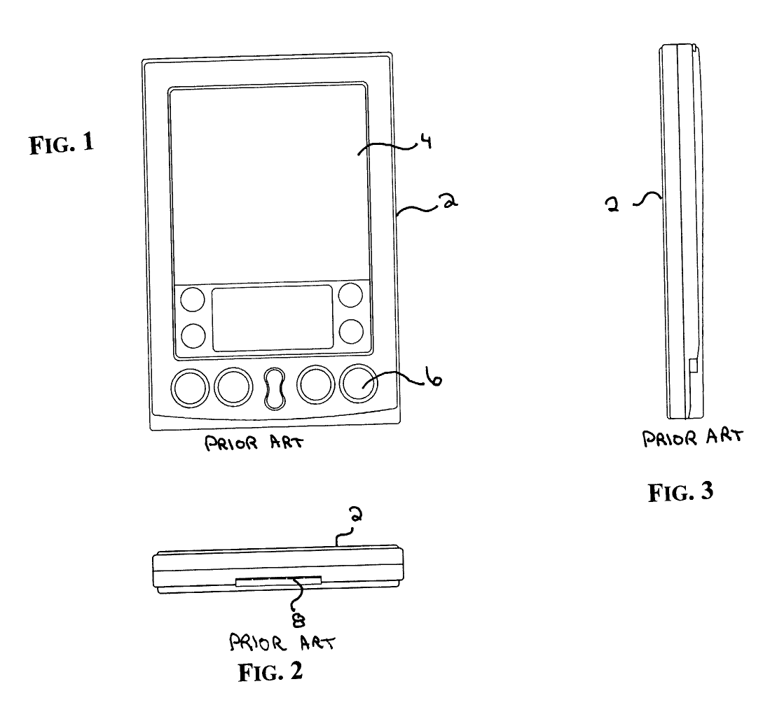

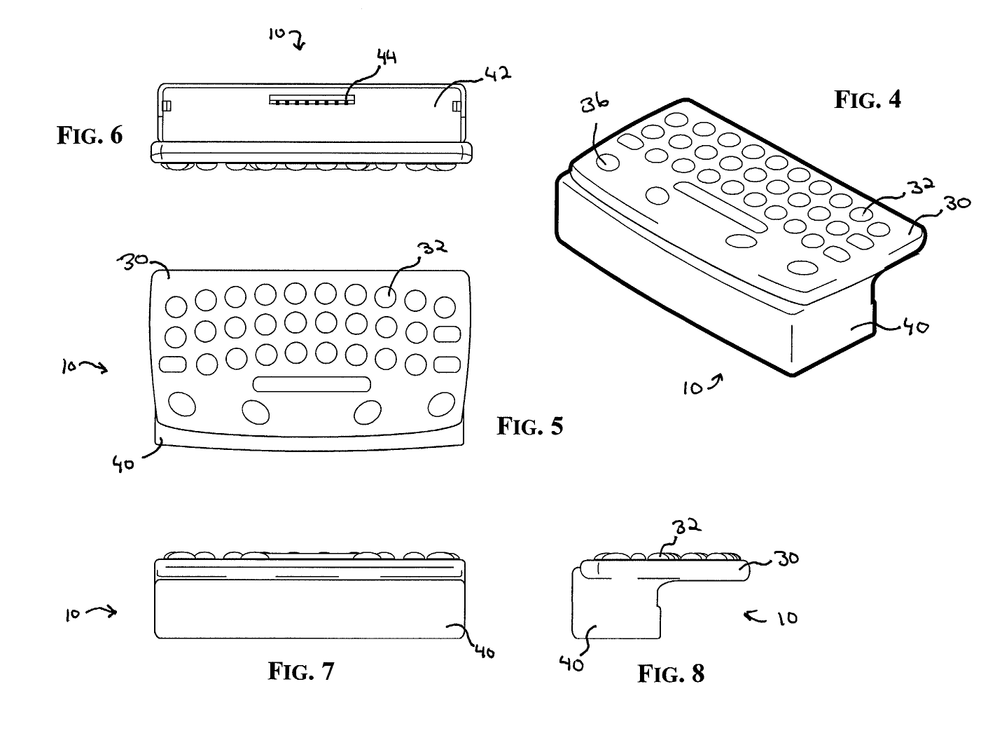

With reference to FIGS. 1-3, a typical prior art personal digital assistant 2 has a screen 4 and several buttons 6. Through the screen 4, information is both displayed and entered. The several buttons 6 located at the bottom portion of the front face are typically for navigation within resident software. As is illustrated in FIG. 2, these pen-based computers 2 usually have an in-out (I/O) port 8 through which additional devices may be electronically coupled.

The attachment 10 comprises two basic sections, a keyboard section 30 and an attachment section 40. The attachment section 40 comprises an attachment enclosure 42 having an I/O connector 44 located within the attachment enclosure 42. The attachment enclosure 42 is generally in the shape of an open-ended box or rectangular prism. The main constraint on the attachment enclosure 42 is that it should be capable of containing the lower end of a PDA 2. In a preferred embodiment the attachment enclosure 42 closely matches the size of the PDA 2 such that the PDA 2 is securely, but removable, contained by the attachment enclosure 42. Since there are a variety of differently shaped PDA's 2 on the market, there may be a variety of differently sized attachment enclosures 42, each of which will have at least one open end and the I/O connector 44 located within.

The I/O connector 44 complementarily fits the I/O port 8 of the PDA 2. The I/O connector 44 in the preferred embodiment of the attachment 10 is designed to mate to the I/O port 8 of a 3COM Palm III PDA. In other embodiments the I/O connector 44 would be specifically configured to other PDAs and other specific pen-based computers. Another embodiment would have an I/O connector 44 that was adaptable to more than one pen-based computer or PDA design.

The keyboard section 30 is generally a flat piece having the keys 32 located on a front side 34. There may be several additional buttons 36 located adjacent to the keys 32. The size and arrangement of the keys 32 are too small to be used with ten-finger typing, but are large enough to be used with one or two fingers (herein thumbs are included in the definition of fingers). The size restriction makes the attachment 10 small enough to be handheld when in use. The keys 32 are preferably an alphanumeric keypad and may be arranged according to any number of standard or non-standard designs. The most common standard design, known to those skilled in the art of keyboard designs as QWERTY, is a most preferred embodiment. Alternately, the keys 32 may be configured in a 10-key design for data entry or inventory control. Other alternatives include key configuration specially designed to meet specific applications. The additional buttons 36 located adjacent the keys 32 are preferably provided for programmable functionality. These buttons 36 allow the user to associate with each button one or more computer commands that will be executed when the button is depressed. In the art, a series of computer instructions associated with a single button or simple command is commonly termed a macro. The ability to execute macros allows the user to take a commonly used and often times lengthy series of computer instructions and run them with the touch of a single button, thus saving the user time by eliminating keystrokes. The implementation of programmable buttons and macros are well known to those skilled in the art.

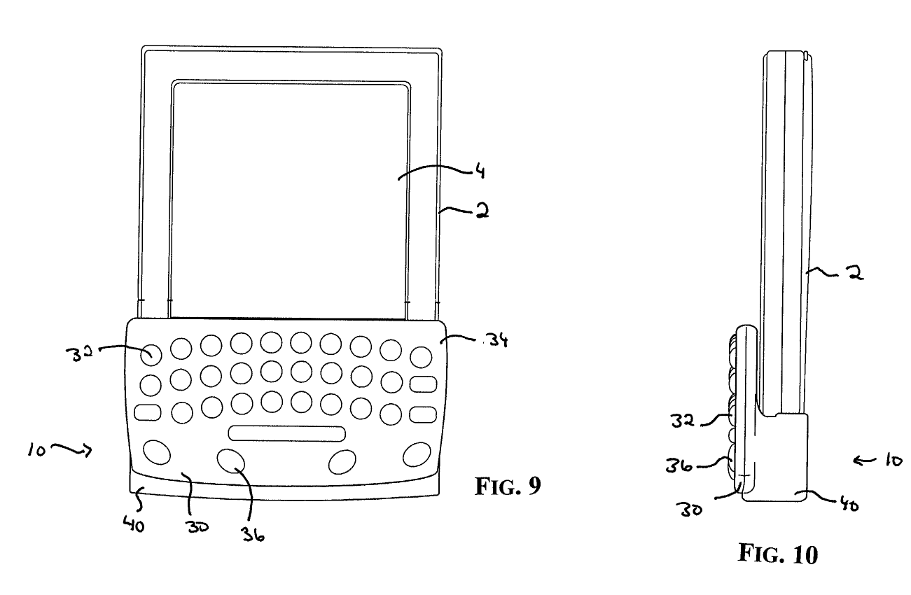

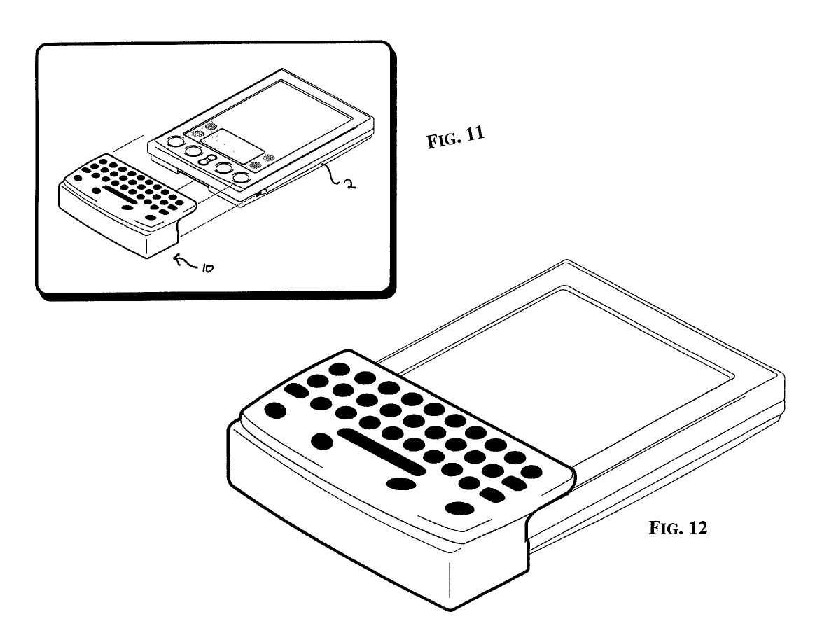

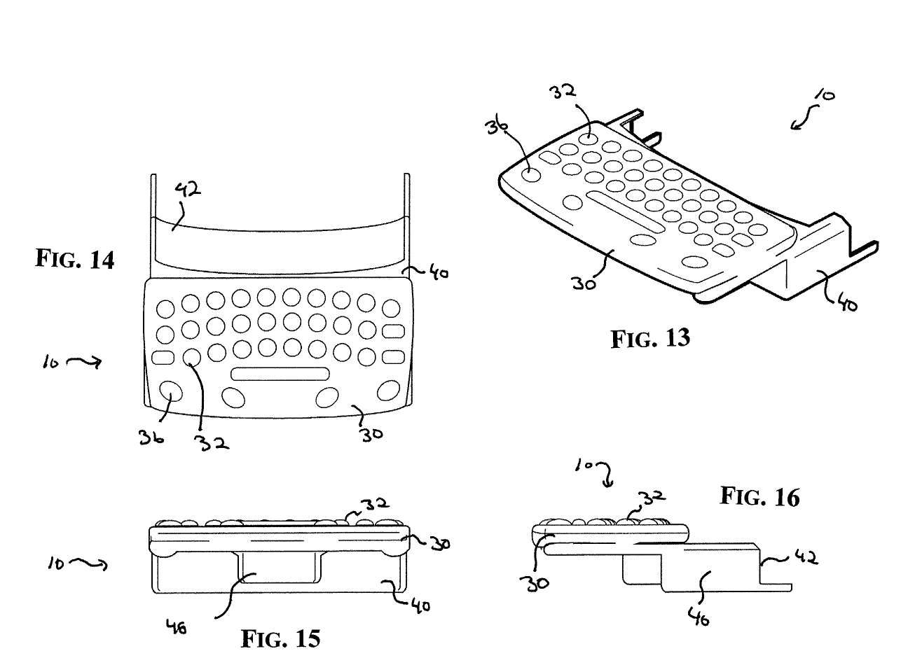

FIGS. 4-12 shows a first embodiment of the attachment 10 according to the present invention. The keyboard section 30 may be integrally to the attachment section 40, forming the front side of the attachment enclosure 42. In this configuration, when the PDA 2 is contained within the attachment enclosure 42, the keyboard section 30 overlays the buttons 6 and a lower portion of the screen 4 of the PDA 2. In use, the lower end of the PDA 2 is slid into the attachment enclosure 42 making sure to seat the I/O connector 44 of the attachment 10 into the I/O port 8 of the PDA 2. Power to operate the attachment 10 is supplied by the PDA 2, thereby obviating the need for a separate power source.

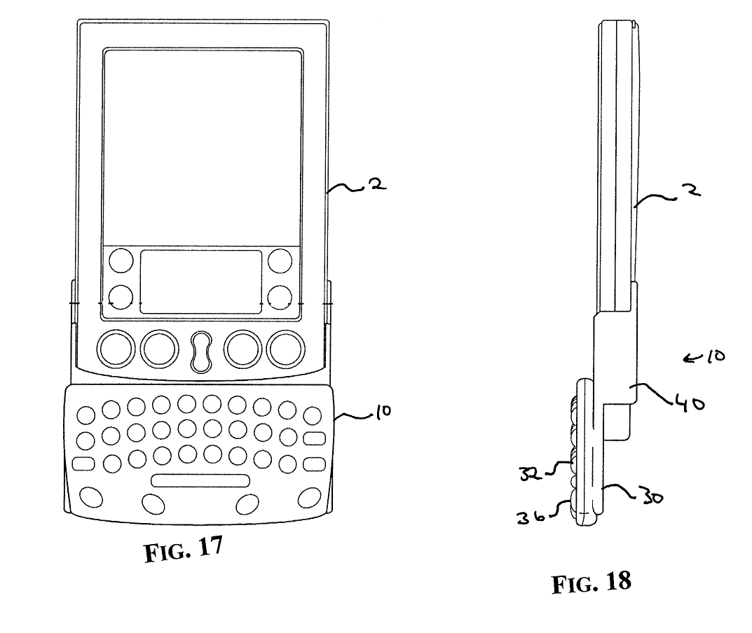

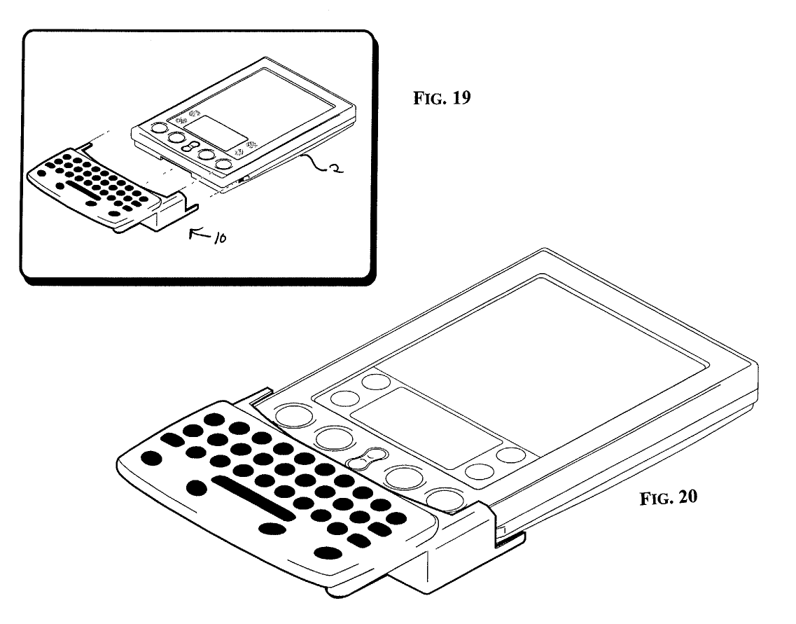

In another embodiment, shown in FIGS. 13-20, the keyboard section 30 may be integrally attached to a lower portion of the attachment section 40. In this configuration, the buttons 6 and lower portion of the screen 6 of the PDA 2 are left open to access by the user. As described above, in use the PDA 2 is slid into the attachment enclosure 42 making sure to seat I/O connector 44 in the attachment enclosure 42 into the I/O port 8 of the PDA 2. In this configuration, there may also be an electrical connection conduit 48 used to route the wires that electrically connect the keyboard 30 piece to the attachment enclosure 42.

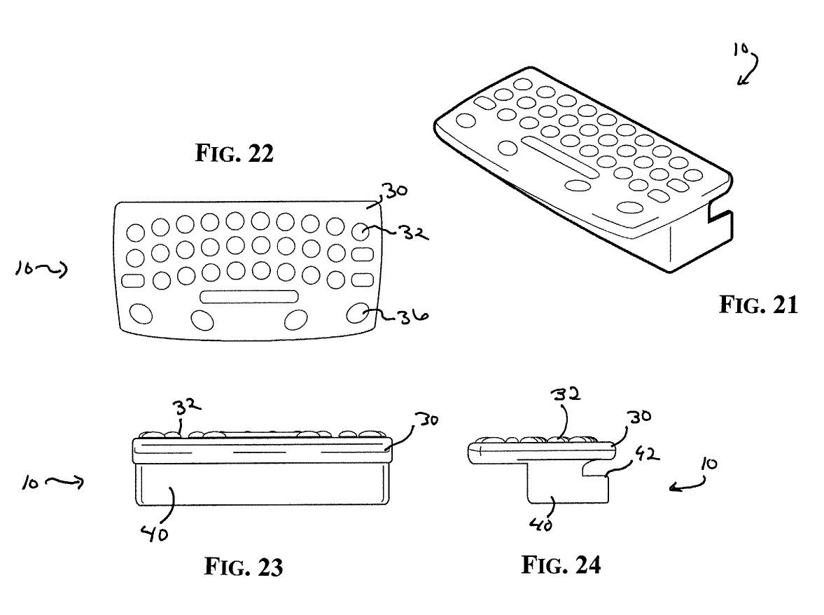

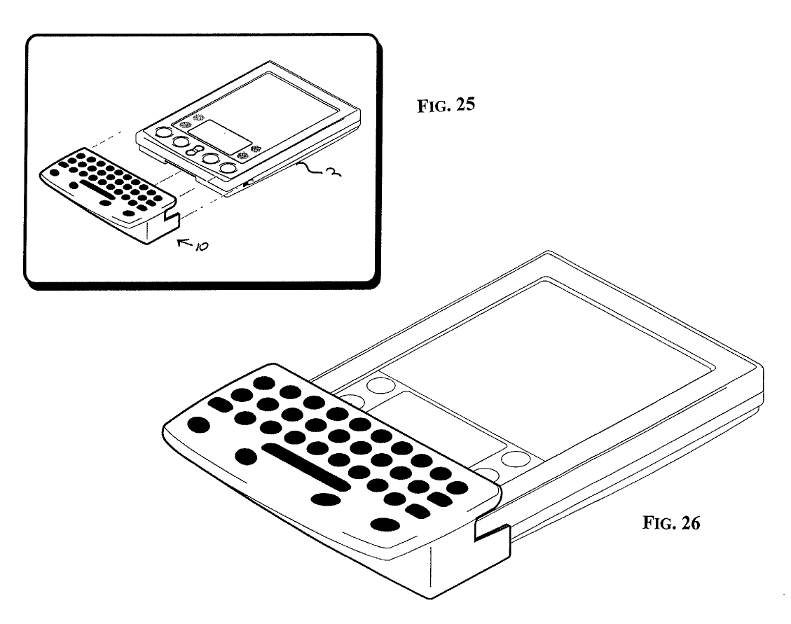

In yet another embodiment, shown in FIGS. 21-26, the keyboard section 30 may be integrally attached to a front portion of the attachment enclosure 42. In this configuration, the keyboard section 30 overlays the buttons 6 located on the lower portion of the PDA 2, but does not overlay the lower portion of the screen 4. In this configuration, the functions of the buttons 6 of the PDA 2 are replace by the keys 32 on the keyboard section 30, with access to the entire screen 4 still retained. As described above, the attachment 10 is secured to the PDA 2 by sliding the lower portion of the PDA 2 into the attachment enclosure 42, making sure to seat the I/O connector 44 in the attachment enclosure 42 into the I/O port 8 of the PDA 2.

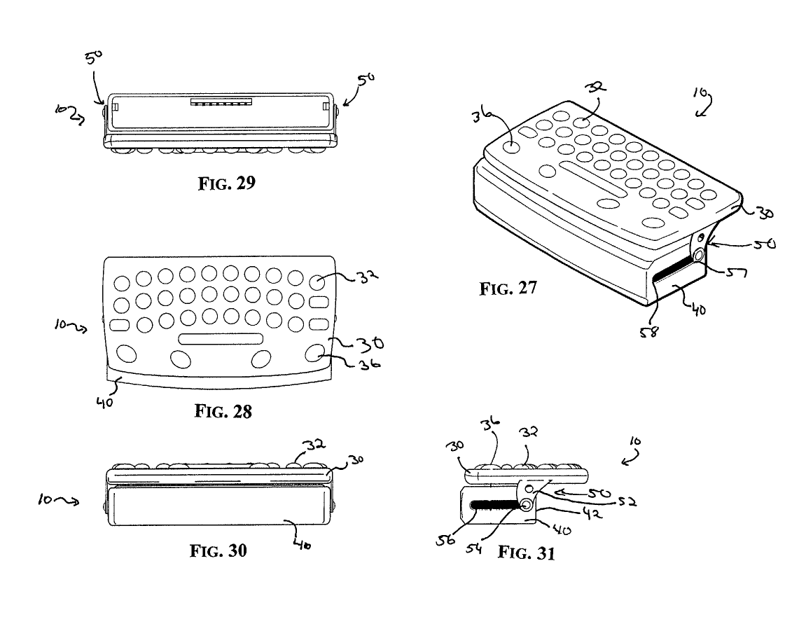

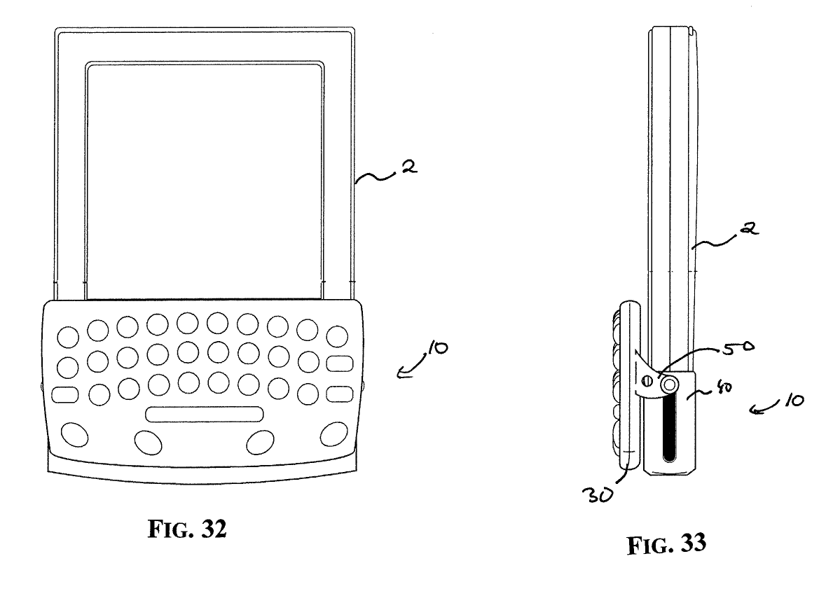

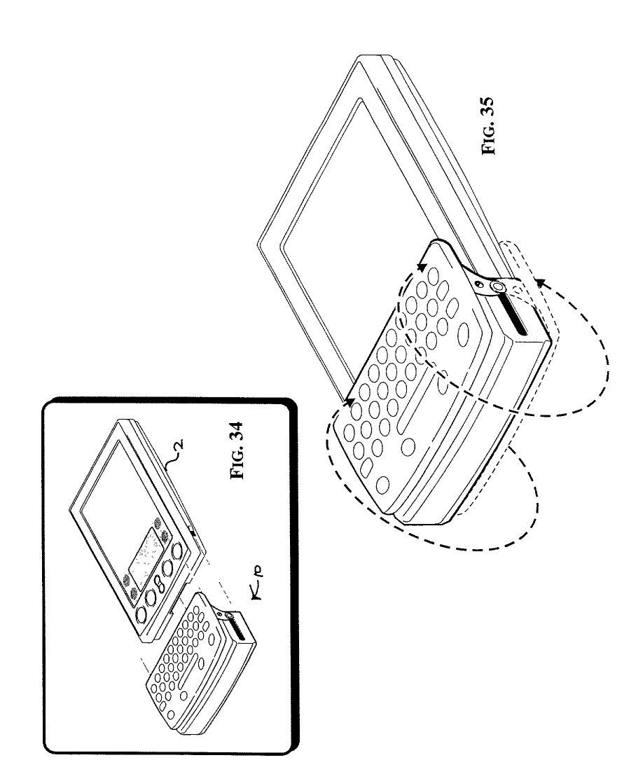

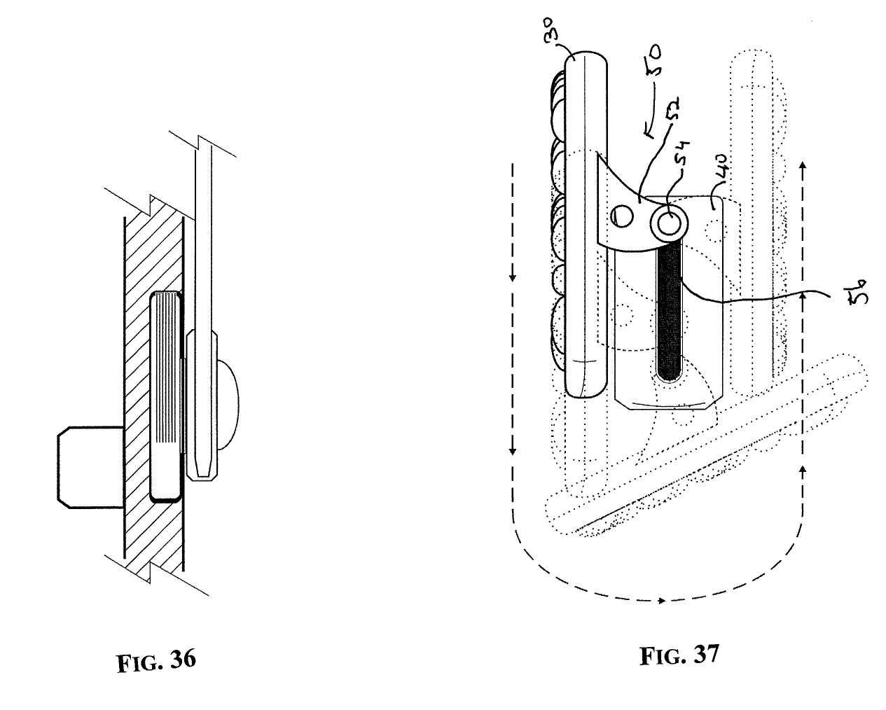

In still yet another embodiment, shown in FIGS. 27-35 the keyboard section 30 may be attached to the attachment enclosure 42 via a sliding hinge mechanism 50. In this configuration, the keyboard section 30 has two basic positions, a use position and a “not-in-use” position. In the use position, the keyboard section 30 overlays either the buttons 6 located on the lower portion of the PDA 2 or both the buttons 6 and lower section of the screen 4 of the PDA 2. In this configuration, the keyboard section 30 replaces the function of the buttons 6 or both the buttons 6 and lower portion of the screen 4. The keyboard section 30 may be moved to the not-in-use position by rotating the keyboard section 30 about a hinge 52 located on either side of the attachment 10. In the embodiment illustrated in FIG. 37, the pivots 54 of the hinge 52 are moved through slots 56 from a first end 57 to a second end 58. The keyboard section 30 is then rotated about the hinge 52 and the pivot 54 then moved back along the slots 56 from the second end 58 to the first end 57. The keyboard section 30 may be in electrical connection to the I/O connector 44 via a flexible ribbon cable (not shown) or the electrical connection could be routed through the hinge mechanism 50. In one embodiment, movement of the keyboard section 30 from the use position to the not in use position disables the function of the keyboard section 30, thereby preventing accidental and/or random key 32 use.

In order that the user may communicate to the PDA 2 by way of the keys 32 and buttons 34 of the keyboard section 30 with programmable functionality, a cable comprising multiple wires connects the I/O connector 44 to the control circuitry (“keyboard controller”; not shown) of the keyboard section 30. The cable also carries power from the I/O connector 44 to the keyboard controller. Suitable keyboard controllers are available from a variety of vendors. These wires are routed from the I/O connector 44 through the interior of the attachment enclosure 42, or through the hinge 50 on the side of attachment enclosure 42 and into the matching hinge connector on the keyboard section 30. A sheath for the wires shown in may help prevent the wires from interfering with the motion of the hinge 50 and also prevents the wires from rubbing and fraying.

While the Figures show preferred arrangements of the components of attachment 10 and keyboard section 30, other embodiments may have different component arrangements. In the preferred embodiment associated computer commands are stored by non-volatile memory when the attachment 10 is not in use. Such memory logic for attachments 10 is well known in the art and commercially available. The preferred embodiment of the present invention draws power from the attached PDA 2 in order to operate the keys 32 of the keyboard section 30 and the buttons with programmable functionality. It is advantageous to draw power from the PDA 2 as this eliminates the need for an external power supply or batteries and thus reduces weight and simplifies the use of the attachment 10. It is further advantageous for the attachment 10 to draw power from the PDA 2 as this guarantees that the keyboard section 30 will always operate whenever the PDA 2 has power.

The preferred embodiment(s) of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A hand held computer keyboard system comprising:
a keyboard portion having a front and a back and defining a support plane and containing a keypad;
a cover portion having an inner surface and an outer surface, said cover portion being coupled proximate to said back of said keyboard portion such that it can pivot from a closed position with said inner surface overlying said keyboard portion and an open position oriented at an angle to said support plane;
an interface assembly coupled to said cover portion, said interface assembly including an I/O connector configured to engage an I/O port of a computerized apparatus as said computerized apparatus is being supported by said inner surface of said cover portion; and
a plurality of wires connecting said I/O connector to said keyboard portion through said interface assembly.

2. A hand held computer keyboard system as recited in claim 1 further comprising:
a stabilizing leg coupled to at least one of said keyboard portion and said cover portion to inhibit rotational movement of said keyboard portion relative to said support plane due to pressure exerted on said cover portion.

3. A hand held computer keyboard system as recited in claim 2 wherein said stabilizing leg is coupled proximate to said back of said keyboard.

4. A hand held computer keyboard system as recited in claim 3 wherein said stabilizing leg can retract into said keyboard portion.

5. A hand held computer keyboard system as recited in claim 2 wherein said stabilizing leg is coupled to said outer surface of said cover portion.

6. A hand held computer keyboard system as recited in claim 5 wherein said stabilizing leg can fold against said cover portion.

7. A hand held computer keyboard system as recited in claim 1 wherein said inner surface of said cover portion may be held at multiple angles relative to said support plane.

8. A hand held computer keyboard system as recited in claim 7 wherein said multiple angles range between 90 and 135 degrees relative to said support plane.

9. A hand held computer keyboard system as recited in claim 1 further comprising a stop coupled to one of said keyboard portion and said cover portion and engaging the other of said keyboard portion and said cover portion to limit the pivotal movement of said cover portion.

10. A hand held computer keyboard system as recited in claim 1 wherein said keypad is arranged in the standard QWERTY format.

11. A hand held computer keyboard system as recited in claim 1 wherein said keypad is arranged in the standard 10-key data-entry format.

12. A hand held computer keyboard system as recited in claim 10 wherein said keyboard portion contains a plurality of buttons in addition to those required by said QWERTY format, said additional plurality of buttons having programmable functionality.

13. A hand held computer keyboard system as recited in claim 11 wherein said keyboard portion contains a plurality of buttons in addition to those required by said 10-key format, said additional plurality of buttons having programmable functionality.

14. A hand held computer keyboard system as recited in claim 1 wherein said keyboard portion contains at least one receptacle for holding a stylus.
